(19) United States
(12) Patent Application Publication
(10) Pub. No.: US 2025/0333329 A1
(43) Pub. Date: Oct. 30, 2025

(54) WATER PURIFICATION SYSTEM AND METHOD USING CARBON DIOXIDE

(71) Applicant: NUOVO PIGNONE TECNOLOGIE SRL, Florence (IT)

(72) Inventors: Manjush Ganiger, Bangalore (IN); Vidyasagar Ramalingam Rengasamy, Bangalore (IN); Balachandran Kumaravelu, Bangalore (IN); Rajesh Srinivasan, Bangalore (IN); Uday Meduri, Bangalore (IN); Gino Baldi, Firenze (IT)

(21) Appl. No.: 18/651,118

(22) Filed: Apr. 30, 2024

(51) Int. Cl. C02F 1/26; C02F 101/00; C02F 101/12; C02F 103/08

(52) U.S. Cl. CPC C02F 1/265; C02F 2101/006; C02F 2101/12; C02F 2103/08

(57) ABSTRACT

A system for purifying impurity-infused water includes a CO₂ input tubular, a CO₂ output tubular, a CO₂ hydrate-former vessel configured to form CO₂ hydrates using the CO₂ from the CO₂ input tubular and the impurity-infused water. The system also includes a CO₂ hydrate-dissociator vessel configured receive CO₂ hydrates from the CO₂ hydrate-former vessel and to dissociate the CO₂ hydrates into purified water and dissociated CO₂ by heating the CO₂ hydrates. The system further includes a CO₂ compressor configured to receive the dissociated CO₂ from the CO₂ hydrate-dissociator vessel, compress the dissociated CO₂, and discharge compressed CO₂ into the CO₂ output tubular. The CO₂ hydrate-former vessel includes an impurity solution output for discharging an impurity solution having impurities removed from the impurity-infused water by the formation of the CO₂ hydrates. The CO₂ hydrate-dissociator vessel includes a heating device configured to heat the CO₂ hydrates to dissociate them.

### BACKGROUND

Water scarcity is a global problem and is anticipated to get worse due to climate change. Currently countries around the world tackle this problem by using energy intensive technologies such as reverse osmosis and multi-stage flash desalination. Unfortunately, these technologies, while largely adopted, have inherent drawbacks. For instance, reverse osmosis uses membranes which are expensive and cannot be used for extremely saline water. Multi-stage flash desalination is extremely energy intensive and has problems with scaling due to the salts. Hence, new technologies that would overcome these drawbacks would be welcomed.

### BRIEF SUMMARY

Disclosed is a system for purifying impurity-infused water includes a CO₂ input tubular configured to contain carbon dioxide (CO₂) at a pressure P1, a temperature T1, and a concentration C1 and a CO₂ output tubular configured to contain CO₂ at a pressure P2, a temperature T2, and a concentration C2. The system also includes a CO₂ hydrate-former vessel configured to form CO₂ hydrates using the CO₂ from the CO₂ input tubular and the impurity-infused water, the hydrate reactor vessel having a CO₂ input coupled to the CO₂ input tubular, an impurity-infused water input coupled to a supply of the impurity-infused water, a CO₂ hydrate output for discharging the formed CO₂ hydrates, and an impurity solution output for discharging an impurity solution having impurities removed from the impurity-infused water by the formation of the CO₂ hydrates. The system further includes a CO₂ hydrate-dissociator vessel configured to dissociate the CO₂ hydrates into purified water and dissociated CO₂ by heating the CO₂ hydrates, the dissociation unit having a CO₂ hydrate input coupled to the CO₂ hydrate output of the hydrate-former vessel, a CO₂ output to discharge the dissociated CO₂, and a heating device configured to heat the CO₂ hydrates. The system further includes a CO₂ compressor configured to compress the dissociated CO₂, the CO₂ compressor comprising a compressor CO₂ input coupled to the CO₂ output of the hydrate-dissociator vessel and a compressor CO₂ output coupled to the CO₂ output tubular.

Also disclosed is a method for purifying impurity-infused water includes receiving carbon dioxide (CO₂) from a CO₂ input tubular configured to contain CO₂ at a pressure P1, a temperature T1, and a concentration C1. The method also includes forming CO₂ hydrates using the CO₂ from the CO₂ input tubular and the impurity-infused water in a CO₂ hydrate-former vessel and dissociating the CO₂ hydrates into purified water and dissociated CO₂ by heating the CO₂ hydrates in a CO₂ hydrate-dissociator vessel. The method further includes compressing the dissociated CO₂ using a CO₂ compressor to provide compressed CO₂ and discharging the compressed CO₂ into a CO₂ output tubular at a pressure P2, a temperature T2, and a concentration C2 within a selected range of C1.

### BRIEF DESCRIPTION OF THE DRAWINGS

The following descriptions should not be considered limiting in any way. With reference to the accompanying drawings, like elements are numbered alike:

FIG. 1 illustrates a simplified embodiment of a water purification unit coupled to a carbon dioxide (CO₂) input tubular for receiving CO₂ to form CO₂ hydrates and a CO₂ output tubular for discharging CO₂ from dissociation of the CO₂ hydrates;

FIG. 2 illustrates a simplified embodiment of the water purification unit where the CO₂ input tubular receives CO₂ from a pressure modification device;

FIG. 3 illustrates a simplified embodiment of a dual-purpose system having an energy generation unit and a water purification unit for generating energy and purifying impurity-infused water;

FIG. 4 depicts aspects of an embodiment of the dual-purpose system having the energy generation unit implementing an Allam power cycle;

FIG. 5 depicts aspects of a piston compressor configured to compress CO₂ using water pressure;

FIG. 6 depicts aspects of the Allam power cycle;

FIG. 7 depicts aspects of another embodiment of the dual-purpose system having the energy generation unit implementing the Allam power cycle;

FIG. 8 depicts aspects of the dual-purpose system having a cryogenic CO₂ separation process unit to supply the CO₂ to the water purification unit;

FIG. 9 depicts aspects of the dual-purpose system in which the energy generation unit includes a gas turbine and a chilled ammonia process CO₂ separator to supply CO₂ to the water purification unit; and

FIG. 10 is a flow chart for a method for purifying impurity-infused water.

### DETAILED DESCRIPTION

A detailed description of one or more embodiments of the disclosed apparatus and method presented herein by way of exemplification and not limitation with reference to the figures, in which like elements are numbered alike.

In the figures, arrows representing flow or conveyance of a fluid may include representing pipes or structures for directing the flow or conveyance. These arrows may also represent any associated components such as valves, pumps, mechanical connectors and fittings and the like needed for flowing or conveying the fluid. Similarly, arrows used to represent conveyance of electric power may represent conductors, cables, electrical connectors, transformers, switchgear and the like needed for the conveyance. While not explicitly discussed or illustrated, the various components of the disclosed apparatus requiring power inherently include a power supply or connection to a power source. Locations where arrows leave or enter a component can represent output ports (or connectors) or input ports (or connectors), respectively, for fluid flow or connections for electrical components. Components may include remotely controlled actuators for controlling the components using a controller. The controller may receive information from sensors distributed throughout the disclosed apparatus for monitoring operation and providing feedback control as needed. Arrows depicting heat transfer may inherently represent a working fluid or heat transfer fluid that transfers the heat.

Certain values of properties such as temperature, pressure, and concentration may be presented in discussing the disclosure. These values are presented for teaching purposes only (such as for presenting value changes or comparing values) and they are not intended to limit the disclosure.

Disclosed are embodiments of systems, apparatuses, and methods for purifying impurity-infused water using carbon dioxide. The term “impurity-infused water” relates to water having a certain level of impurities that renders the water not suitable for an intended purpose. Non-limiting examples of the impurity-infused water include salt-infused water such as ocean saltwater (i.e., seawater), brackish water, and/or radioactive element-infused water. The discussion presented below discusses desalinating salt-infused water for teaching purposes. However, the disclosure is also applicable to purifying water infused with other types of impurities.

An input tubular such as a pipeline supplies carbon dioxide (CO₂) to a water purification system. The CO₂ may be cooled, or used directly if at appropriate pressure and temperature, and mixed with salt-infused water (i.e., impurity-infused water) to form CO₂ hydrates. The CO₂ hydrates may be viewed as a volume of CO₂ gas enveloped by a layer or shell of frozen desalinated water (e.g., pure water). Due to the formation of the CO₂ hydrates, the brine (i.e., impurity solution) is separated from the salt-infused water and discharged. The CO₂ hydrates are then dissociated by heating the CO₂ hydrates to provide substantially pure water (e.g., 95-100% pure) and CO₂ gas, which is compressed and provided back to a second tubular where the discharged stream of CO₂ can be ultimately captured and sequestered.

Various types of systems, referred to herein as upstream systems, may supply the CO₂ to the input tubular. Non-limiting embodiments of these types of systems include energy generation systems, such as Allam cycle power generation systems, which discharge a stream of CO₂ in the process of generating energy. Other non-limiting embodiments include cryogenic CO₂ separation systems that separate or scrub CO₂ from a combustion exhaust stream such as from a gas turbine to provide a stream of CO₂ to the first tubular.

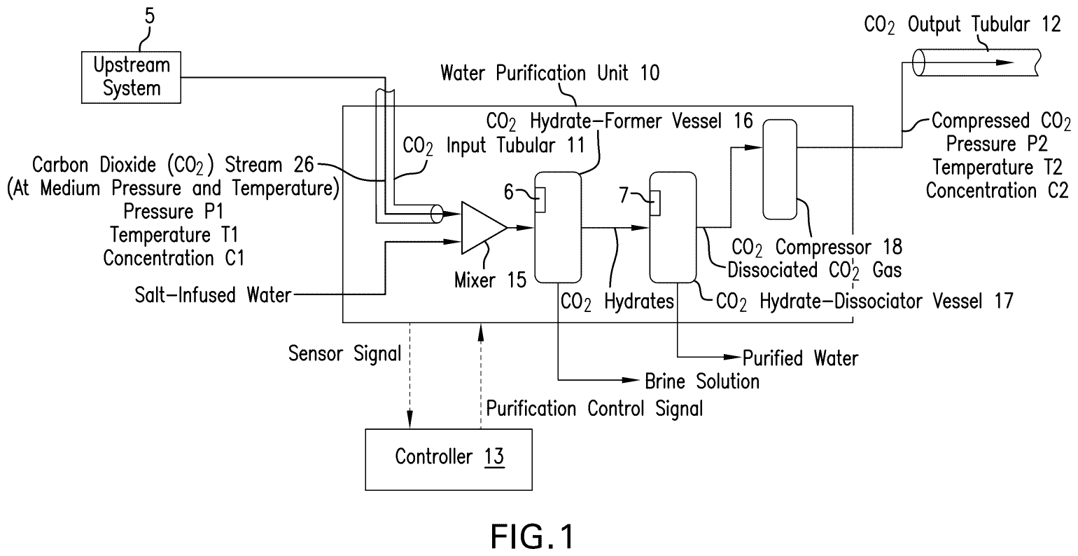

FIG. 1 illustrates a simplified embodiment of a water purification section 10 configured to purify salt-infused water by the formation and dissolution of CO₂ hydrates. The water purification section 10 is coupled to a CO₂ input tubular 11 and a CO₂ output tubular 12. The CO₂ input tubular 11 is configured to convey CO₂ to the water purification section 10. An upstream system 5 is coupled to and supplies the CO₂ to the CO₂ input tubular 11. In the embodiment of FIG. 1, the CO₂ supplied by the upstream system 5 is at a pressure, temperature, and concentration compatible with the formation of the CO₂ hydrates. In one or more embodiments, the CO₂ is at pressure P1 is in a range of 25 to 35 bar, temperature T1 is in a range of −80 to −4° C., and concentration of CO₂ C1 is greater than 20 mol %. The output tubular 12 is configured to convey CO₂ discharged by the water purification section 10 after the salt-infused water is purified. The water purification section 10 also is coupled to an input of salt-infused water that is to be purified.

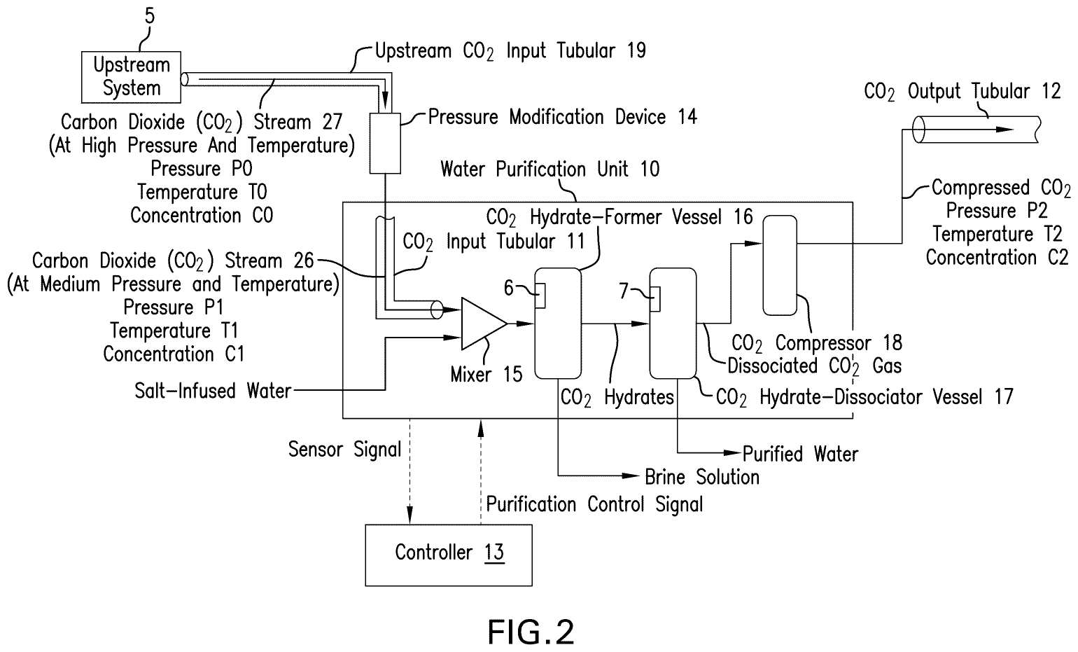

Depending on the parameter values of the CO₂ supplied by the upstream system 5, a pressure modification device 14 (e.g., a pressure reduction device such as an expansion valve or pressure reducing valve for decreasing pressure or a compressor for increasing pressure) may be disposed in-line with the CO₂ input tubular 11 to change the pressure and temperature of the CO₂ to desired values suitable for CO₂ hydrate formation as illustrated in FIG. 2. In the embodiment of FIG. 2, exemplary suitable parameter values are pressure P1 is in a range of 25 to 35 bar, temperature T1 is in a range of −80 to −4° C., and concentration of CO₂ C1 is greater than 20 mol %. The CO₂ in a CO₂ stream 27 from the upstream system 5 at pressure P0, temperature T0, and concentration C0 may be flowed in an upstream CO₂ tubular 19 to the pressure modification device 14 as illustrated in FIG. 2. Pressure reduction using the expansion valve cools the CO₂ by expansion and reduction of pressure to a temperature and pressure suitable for CO₂ hydrate formation. The CO₂ at the suitable temperature and pressure is mixed with an input of salt-infused water from a supply of salt-infused water in a mixer 15 to output a mixture of the CO₂ and the salt-infused water. The mixture is provided to a hydrate-former vessel 16 where the CO₂ hydrates are formed. The CO₂ hydrates are then provided to a CO₂ hydrate-dissociator vessel 17. The CO₂ hydrate-dissociator vessel 17 is configured to dissociate CO₂ hydrates into their constituent components of purified water and the CO₂ gas (i.e., the gas used to form the CO₂ hydrates) by heating the CO₂ hydrates such that the outer shell of purified water melts. The purified water is then discharged from the CO₂ hydrate-dissociator vessel 17 and provided to a tubular for supplying purified water. The heating to dissociate the CO₂ hydrates is provided by a heating element 7. The heating element 7 may receive energy such as electricity or heat energy from a heat-transfer fluid such as water or steam. The energy may be provided by an energy generation section supplying the CO₂ to the input tubular 11 or other energy source.

The dissociated CO₂ gas is provided to a CO₂ compressor 18 that is configured to compress the CO₂ to a selected pressure that is suitable for flowing the compressed CO₂ gas into the output tubular 12. The CO₂ compressor 18 may be motor driven such as by an electric motor or driven by fluid pressure such as water discharged from a pump in a configuration discussed further below.

Also illustrated in FIGS. 1 and 2 is a controller 13, which may be part of the water purification section 10. The controller 13 receives input from various sensors distributed throughout the water purification section 10. Non-limiting embodiments of the sensors include pressure sensors, temperature sensors, flow sensors, level sensors, optical sensors, and/or speed sensors. The controller 13 is configured to implement an algorithm to output a control signal to a remotely controlled device for desired operation of the water purification section 10 at a selected setpoint parameter value or in a range of selected parameter values. Control may be on-off or continuously variable. Non-limiting embodiments of the remotely controlled device include a valve, damper, pump, compressor, and switchgear for controlling an electrically powered device. Non-limiting embodiments of the algorithm include proportional, integral, and/or derivative (PID) feedback control, model-based control, and machine-learning control including artificial intelligence.

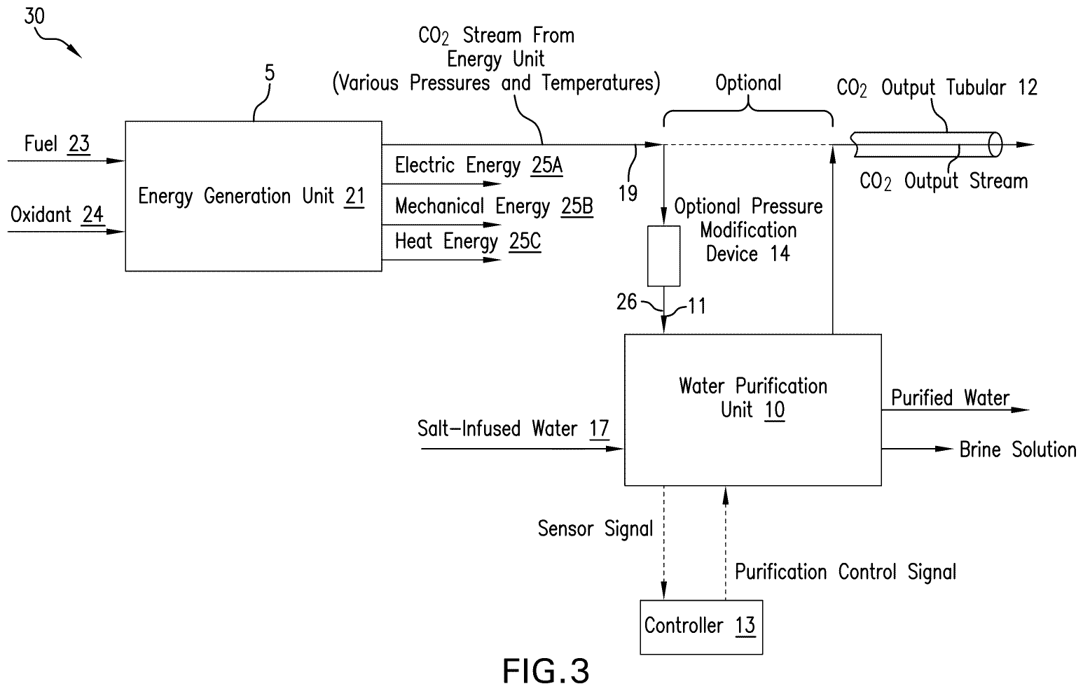

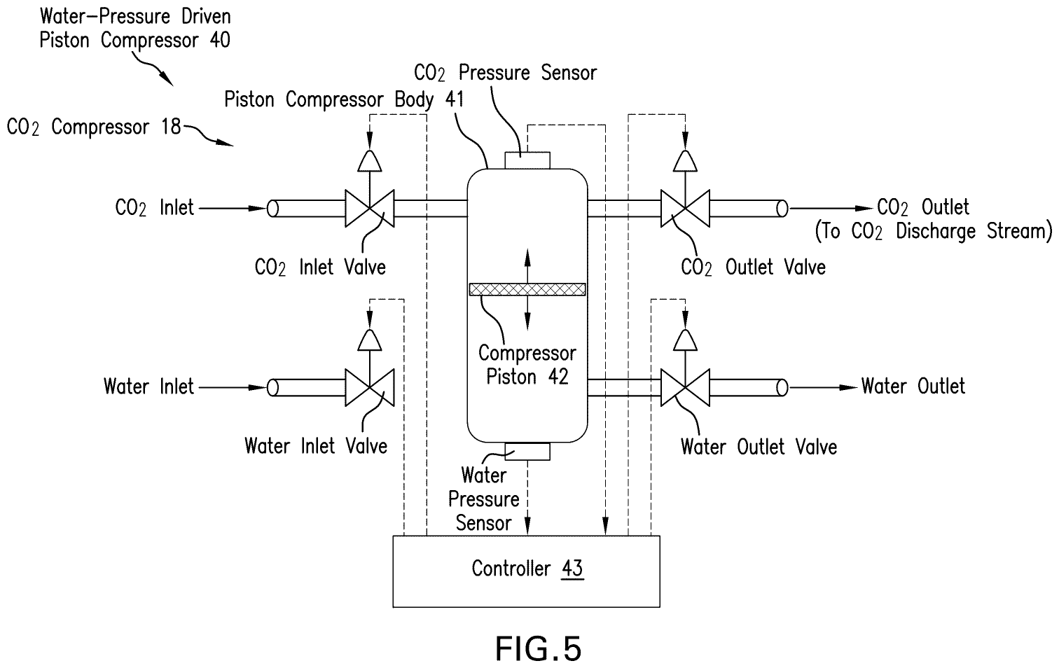

FIG. 3 illustrates a simplified embodiment of a dual-purpose system 30 having an energy generation section 21 and the water purification section 10 for generating energy and purifying salt-infused water. The energy generation section 21 is configured to combust a fuel 23 and an oxidant 24 to generate energy 25. The combustion may be part of a power cycle that can provide the energy as electric energy 25A, mechanical energy 25B, and/or heat energy 25C. The electric energy 25A may be generated using an electric generator (not shown) coupled to a heat-energy converter (not shown) such as a turbo-expander in a non-limiting embodiment. A non-limiting embodiment of the mechanical energy 25B is rotation of a drive shaft (not shown) that may be driven to a turbo-expander. The heat energy 25C may be provided directly by mass flow of a working fluid of the power cycle to a user facility or indirectly by transfer of heat energy from the working fluid to a heat transfer fluid using a heat exchanger (not shown). As a result of operation of the power cycle, a CO₂ stream 26 is discharged in a confined manner such as in the tubular 11 or 19. In one or more embodiments, the power cycle is an Allam power cycle using CO₂ as the working fluid with the CO₂ being pressured and/or heated to a supercritical state. The Allam power cycle is discussed in more detail further below referring to FIG. 5. In one or more embodiments, the CO₂ is compressed to a supercritical state and then it is mixed with oxygen (O₂) and fuel, and the mixture is combusted. After generating energy the CO₂ is recompressed to supercritical state.

Optionally in the embodiment of FIG. 3, the input tubular 11 or 19 and the output tubular 12 may be one continuous tubular such that the water purification section 10 receives at least a portion of the CO₂ from the stream of CO₂ 26 discharged by the energy generation section 21 in the input tubular 11. Accordingly, the compressed CO₂ gas is then fed back to the stream of CO₂ 26.

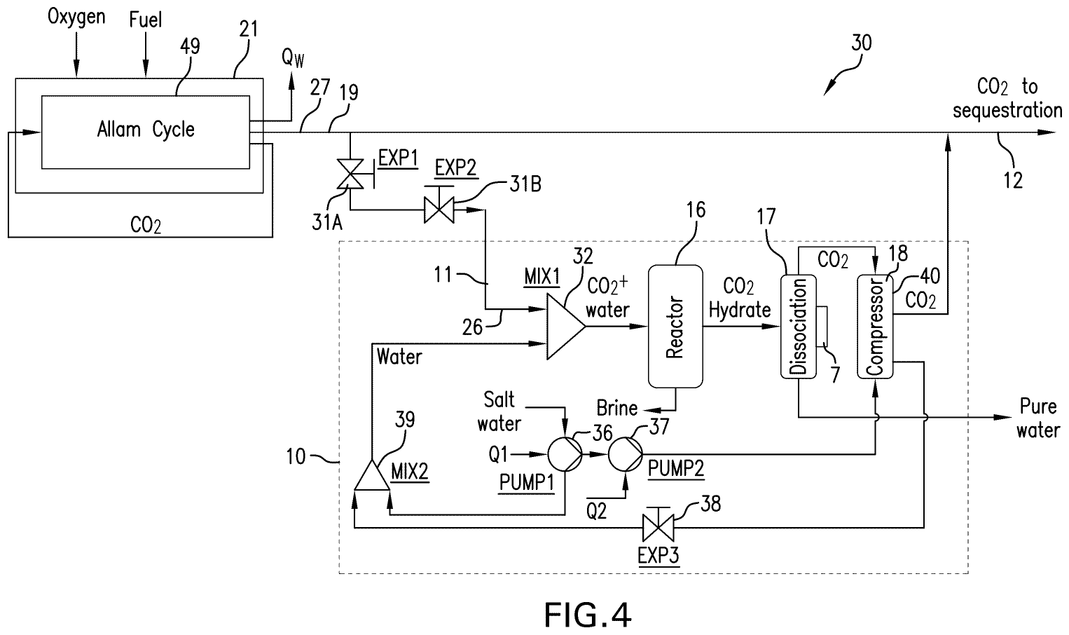

FIG. 4 depicts aspects of an embodiment of a dual-purpose system 30 having the energy generation section 21 implementing an Allam power cycle 49. The Allam power cycle 49 combusts a fuel, generally natural gas, and oxygen to heat CO₂ to a supercritical state and generate energy Q_{w}. The process discharges the stream of CO₂ 26 and also recycles a portion of the discharged CO₂ into the combustion process to lower oxygen input requirements. In one or more embodiments, the stream of CO₂ 26 is at 100 bar pressure, 23° C. temperature, and greater than 20 mol % CO₂ concentration.

In the embodiment of FIG. 4, the pressure and correspondingly the temperature of the CO₂ received by the water purification unit 10 is reduced by two pressure-reducing valves 31A and 31B. These valves may each be referred to as a pressure reduction device. The pressure-reducing valve 31A reduces the pressure of the CO₂ received from the stream of CO₂ 26 from 100 bar to 30 bar and the temperature from 23° C. to −5° C. The pressure-reducing valve 31B further reduces the pressure to 27 bar and the temperature to −9° C. A first mixer 32 receives the CO₂ from the pressure reducing valves and mixes it with the salt-infused water at 27 bar and 25° C. The salt-infused water is received from a supply of salt-infused water. The first mixer 32 discharges a mixture of CO₂ and salt-infused water at 27 bar and −2° C., which is suitable for CO₂ hydrate formation. In one or more embodiments, the first mixer 32 is a vessel having input ports for receiving the CO₂ and salt-infused water and a discharge port for discharging the mixture.

The discharged mixture of the CO₂ and salt-infused water is input into the CO₂ hydrate-former vessel 16 where the mixture forms CO₂ hydrates. Salt or brine is removed from the salt-infused water as the CO₂ hydrates are formed. The brine or brine solution is drained from the hydrate-former vessel 16. In one or more embodiments, the hydrate-former vessel 16 includes an input port for receiving the mixture of the CO₂ and salt-infused water, an output port for discharging the CO₂ hydrates, and an output port for draining the brine solution. The hydrate-former vessel 16 also includes a cooling system 6 to maintain the desired temperature for hydrate formation. Non-limiting embodiments of the cooling system 6 include a coil in the hydrate-former vessel 16 or a jacket surrounding the hydrate-former vessel 16 that receives cold water. The cold water may be provided in a closed loop by a chilled water system.

After separating the CO₂ hydrates, the CO₂ hydrates flow from the CO₂ hydrate-former vessel 16 to the CO₂ hydrate-dissociator vessel 17 where the CO₂ hydrates are dissociated into CO₂ and desalinated water by applying heat to the CO₂ hydrates using the heating element 7. Structurally, the CO₂ hydrate-dissociator vessel 17 defines a volume for containing the CO₂ hydrates while they are heated, an input port for receiving the CO₂ hydrates, an output port for discharging the purified water, and an output port for discharging the dissociated CO₂ gas.

The CO₂ discharged from the CO₂ hydrate-dissociator vessel 17 flows to the CO₂ compressor 18 where that CO₂ is compressed to a pressure suitable for the discharging of the compressed CO₂ into the output tubular 12. In one or more embodiments where the input tubular 11 and the output tubular 12 is one continuous tubular, the pressure of the compressed CO₂ is suitable for flowing the compressed CO₂ into the stream of CO₂ 16 discharged from the energy generation unit 21. One continuous tubular may be used when the CO₂ input tubular 11 or 19 provides more CO₂ than can be used by the water purification section 10. In this situation, the excess CO₂ flows directly to the CO₂ output tubular 12 where the excess CO₂ is joined by the CO₂ discharged by the water purification section 10.

In the embodiment of FIG. 3, the CO₂ compressor 18 is a water-pressure driven piston CO₂ compressor 40 where one side of a piston compresses the CO₂ and the other side of the piston is driven by water pressure high enough to compress the CO₂ to the pressure needed to flow the CO₂ into the output tubular 12. Aspects of the water-pressure driven piston CO₂ compressor 40 are discussed further below.

As illustrated in FIG. 4, a first pump 36 pumps the salt-infused water from the supply of salt-infused water to a first pressure. The first pressure is compatible with the pressure of the CO₂ entering the first mixer 32 such as for example 27 bar. The first pump 36 has two outputs. A first output supplies water at the first pressure to a second pump 37, which pressurizes the pumped water to a second pressure, which is high enough to compress the CO₂ to the pressure needed to flow the CO₂ into the output tubular 12. The output of the second pump 37 is coupled to a water-side input of the water-pressure driven compressor. In one or more embodiments, the pumps 36 and 37 are driven by electric motors with the first pump 36 using Q1 power and the second pump 37 using Q2 power.

A second output of the first pump 36 is coupled to a first input of a second mixer 39. A water-side output of the CO₂ compressor 40 discharges pressurized water to a third pressure reducing valve 38 (also referred to an expansion valve), which reduces the pressure to approximately the first pressure of the outputs of the first pump 36. The output of the third pressure reducing valve 38 is coupled to a second input of the second mixer 39. The second mixer 39 mixes flows from the third pressure reducing valve 38 and the first pump 36 to provide a mixed flow of salt-infused water to an input of the first mixer 32 at 27 bar and 25° C. for example.

FIG. 5 depicts aspects of the water-pressure driven CO₂ compressor 40. The water-pressure driven CO₂ compressor 40 includes a piston compressor body 41 and a compressor piston 42. The compressor piston 42 is moveable within the body 41. The compressor piston 42 may include a piston ring (not shown) to seal a CO₂ side of the piston from a water-side of the piston in the body. The volume in the body on the CO₂ side of the piston is coupled to a CO₂ inlet valve and a CO₂ outlet valve. The volume in the body on the water-side of the piston is coupled to a water inlet valve and a water outlet valve. The inlet and outlet valves are remotely controlled by a controller 43. The controller 43 receives input from a water pressure sensor and a CO₂ pressure sensor. The controller 43 implements an algorithm to open and close the valves in a defined order in order to use water pressure from the second pump 37 to compress the CO₂ to the suitable CO₂ discharge pressure. Other configurations of water-based compression may be used.

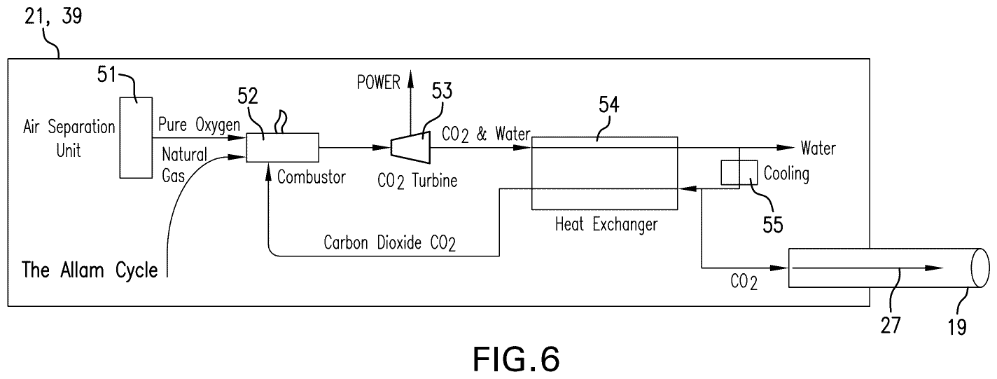

FIG. 6 illustrates a simplified diagram of the Allam power cycle 49 used for the energy generation section 21. The Allam power cycle 49 includes an air separation unit (ASU) 51 that separates oxygen from ambient air to provide substantially pure oxygen to a combustor 52. The combustor 52 combusts a fuel such as natural gas, the substantially pure oxygen, and recycled supercritical CO₂. The recycled CO₂ lowers combustion flame temperature and dilutes the combustion products such that the working fluid is predominantly CO₂. The combustion results in the CO₂ being in a supercritical state. A recuperative heat exchanger 54 and a cooler unit 55 cool the working fluid to provide a differential pressure across a turbo-expander 53 thereby causing the supercritical CO₂ to expand and flow through the turbo-expander 53 urging blades and shaft of the turbo-expander to rotate. The turbo-expander 53 is coupled to an electric generator (not shown), which generates electric power that may be provided to an electric grid. The CO₂ working fluid exhausts the turbo-expander 53 as a mixture of subcritical CO₂ mixed with combustion derived water. The cooling of the working fluid enables liquid water to be removed from the working fluid such as with a water separator (not shown). A portion of the remaining CO₂ is heated by the recuperative heat exchanger 54 and recycled to the combustor 52. A remaining portion of the CO₂ is discharged as the CO₂ stream 26 or 27 depending on whether the pressure modification device 14 is needed. In that the Allam power cycle is known in the art, the Allam power cycle is not discussed herein in further detail.

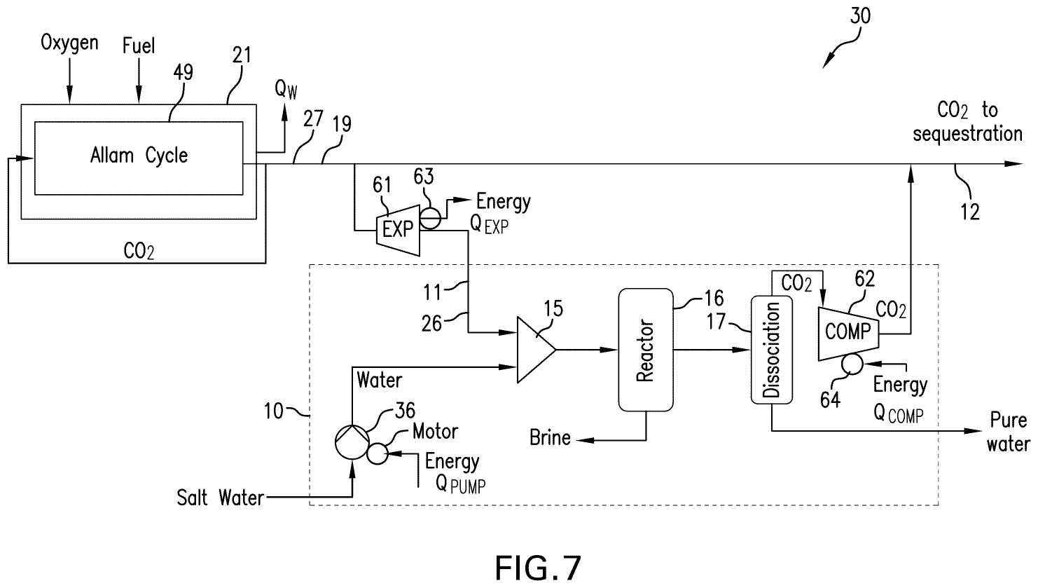

FIG. 7 depicts aspects of another embodiment of the dual-purpose system 30 having the energy generation section 21 implementing the Allam power cycle 49. The embodiment of FIG. 7 is similar to the embodiment of FIG. 4 with two exceptions. The first exception relates to the pressure reducing device being a turbo-expander 61 replacing the two pressure-reducing valves 31A and 31B (or in addition to a pressure reducing valve). The turbo-expander 61 is coupled to an electric generator 63 to generate Q_{EXP} power. The second exception relates to a motor-driven CO₂ compressor 62 replacing the water-pressure driven CO₂ compressor 40. A motor 64 of the motor-driven CO₂ compressor 62 uses Q_{COMP} power to compress the CO₂ from the CO₂ hydrate-dissociator vessel 17 to the pressure needed to discharge the compressed CO₂ into the output tubular 12. The first pump 36 is also motor driven and uses Q_{PUMP} power to pump the salt-infused water from an ambient pressure supply to 27 bar at 25° C. for example. Power for the motor-driven compressor 62 and/or the first pump 36 may be supplied by the electric generator 63 coupled to the turbo-expander 61. Any additional power requirements may be met by the energy generation section 11 generating Q_{W} power.

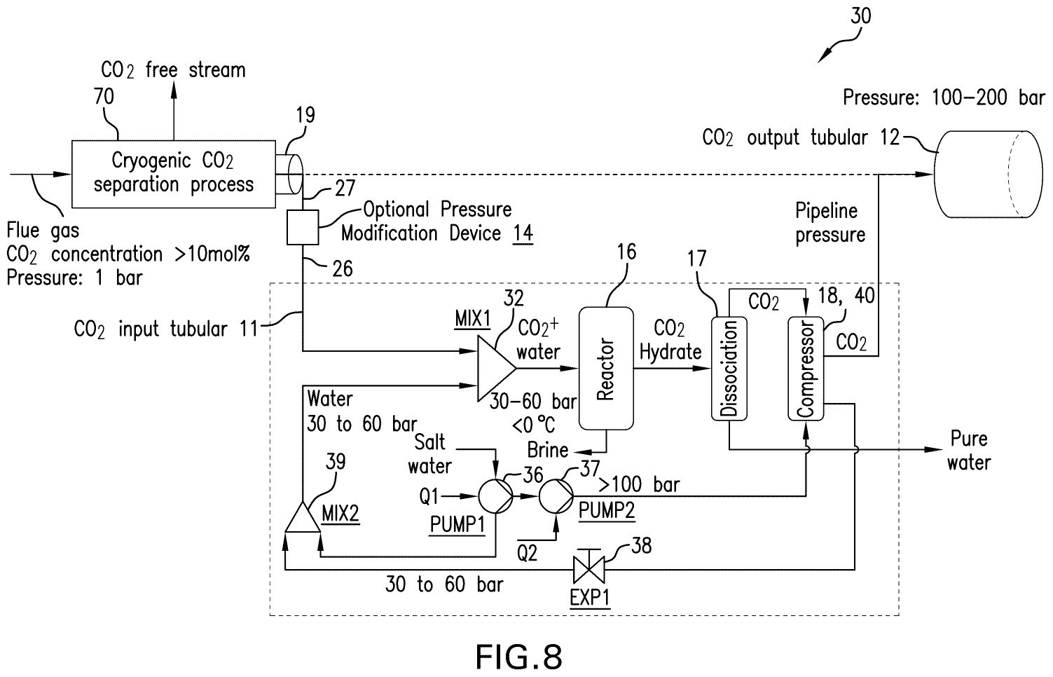

FIG. 8 depicts aspects of yet another embodiment of the dual-purpose system 30. In the embodiment of FIG. 8, a cryogenic CO₂ separation unit 70 is coupled to the CO₂ input tubular 11 and is configured to discharge the stream of CO₂ 26 into the CO₂ input tubular 11. The cryogenic CO₂ separation unit 70 is configured to separate CO₂ from a flue gas stream such as generated by combustion. In one or more embodiments, the flue gas is cooled to a very cold temperature such as negative 120° C. (i.e., −120° C.) to essentially freeze the CO₂ (e.g., as dry ice) out of the flue gas and then the CO₂ solids are separated from the gases. The CO₂ as a solid is allowed to liquify or to vaporize for flowability but is still very cold when it enters the CO₂ input tubular 11. In one or more embodiments, the CO₂ in the CO₂ input tubular 11 is at 5 to 60 bar, is in a temperature range of −80 to −4° C. and has a CO₂ concentration greater than 70 mol %. In addition, the cryogenic CO₂ separation unit 70 may emit a CO₂ free stream devoid of or mostly devoid of CO₂ and thus having a CO₂ concentration less than 3 mol %. In one or more embodiments, the seawater pumped to the sweater pumped to the second mixer 39 is also at a pressure of 5 to 60 bar to be compatible with the pressure of the CO₂ received from the CO₂ input tubular 11. In that the CO₂ liquid or gas is still very cold and thus cold enough to form CO₂ gas hydrates, the optional pressure modification device 14 is not needed and the CO₂ gas flows directly from the CO₂ input tubular 11 to the first mixer 32. The rest of the water purification section 10 is essentially the same as the water purification sections 10 in the embodiments of FIGS. 3 and 5, but without the pressure modification device 14 (i.e., an expansion valve or a turbo-expander). Other types of CO₂ cryogenic separation processes that discharge cold CO₂ gas at a temperature suitable for forming CO₂ gas hydrates may also be used. In that various CO₂ cryogenic separation processes are known in the art, they are not discussed herein in further detail.

In an alternative embodiment with respect to FIG. 8, the CO₂ gas from the a cryogenic CO₂ separation unit 70 may be mixed with warm seawater and thus require further cooling such that the mixture of the CO₂ gas and the seawater is at a sufficiently low temperature to form the CO₂ hydrates. Accordingly, the pressure modification device 14 for reducing pressure may be disposed upstream of the mixer 15 to reduce the pressure of the CO₂ gas and thus further lower the temperature of the CO₂ gas. In one or more embodiments for this configuration, P1 is in a range of 30-60 bar and T1 is less than −10° C.

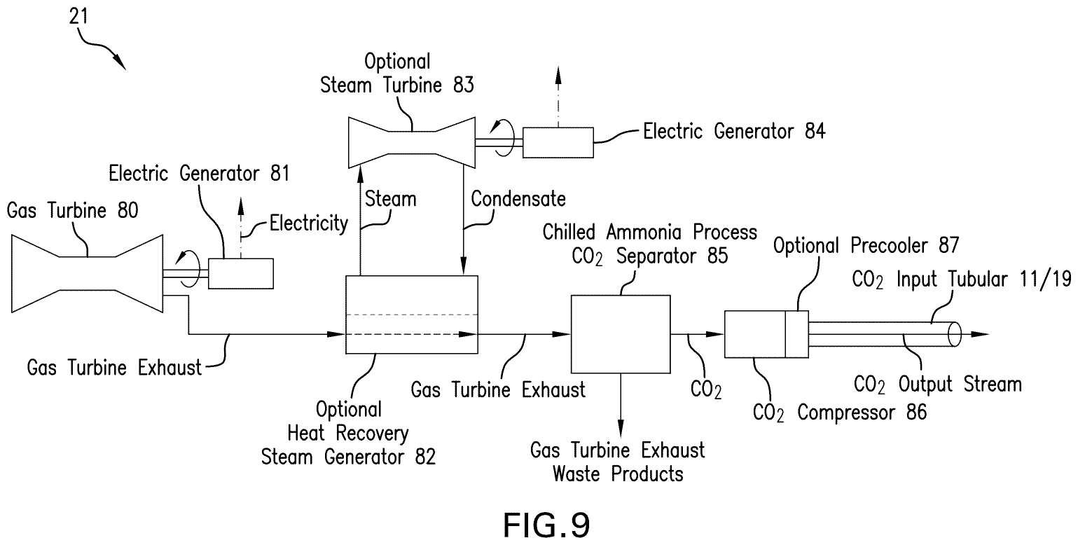

FIG. 9 depicts aspects of the dual-purpose system 30 in which the energy generation unit 21 includes a gas turbine and a chilled ammonia process CO₂ separator to supply CO₂ separated from the turbine exhaust to the water purification unit 10. In the embodiment of FIG. 9, a gas turbine 80 coupled to an electric generator 81 combusts a fuel and an oxidizer to generate electricity. The electric generator 81 may also be representative of any mechanical drive system for receiving mechanical energy generated by the gas turbine 80. In one illustrated embodiment, the turbine exhaust flows directly to a chilled ammonia process CO₂ separator 85 that is configured to separate CO₂ from the turbine exhaust. The separated CO₂ is then provided to a CO₂ compressor 86 that is configured to compress the CO₂ to a selected pressure for being discharged into the CO₂ input tubular 11. Optionally, a precooler 87 may be coupled to an output of the compressor 86 and configured to precool the compressed CO₂ received from the compressor 86. In that various chilled ammonia processes for separating CO₂ from a combustion exhaust stream are known in the art, they are not discussed herein in further detail. In an alternative embodiment illustrated in FIG. 8, a heat recovery steam generator (HRSG) 82 is disposed in the turbine exhaust path prior to the chilled ammonia process CO₂ separator 85. The HRSG 82 is configured to generate steam using heat from the turbine exhaust. The steam is provided to a steam turbine 83 that is coupled to an electric generator 84 for generating further electricity. The electric generator 84 may also be representative of any mechanical drive system for receiving mechanical energy generated by the steam turbine 83. The steam is condensed after flowing through the steam turbine 83 and the resulting condensate is cycled back to the HRSG 82. The energy generation unit 21 having the gas turbine and steam turbine may be referred to as a combined cycle power unit.

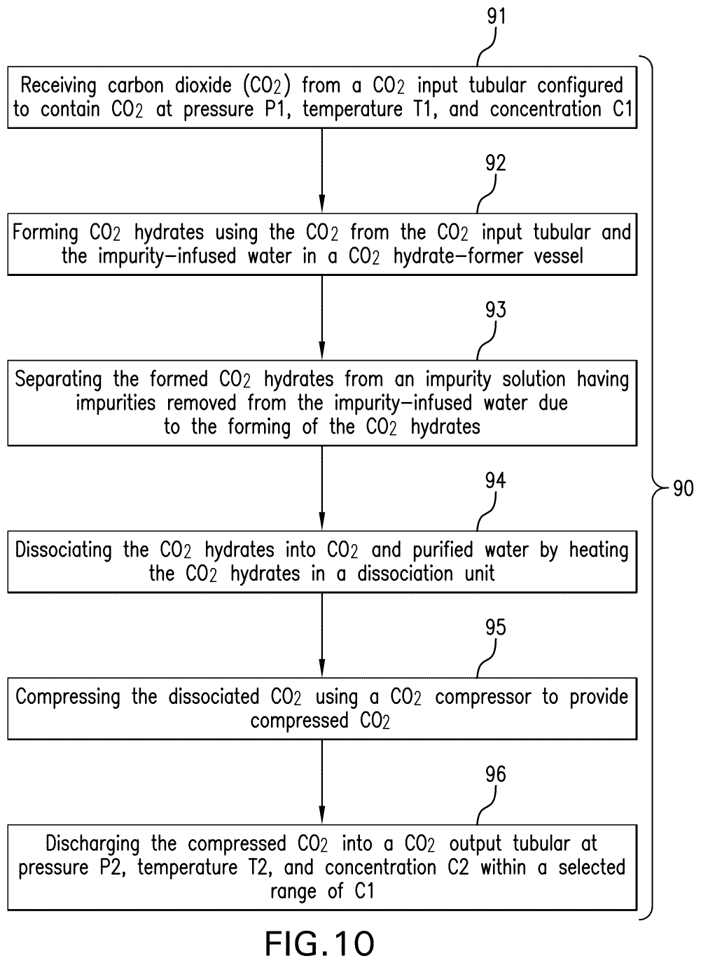

FIG. 10 is a flow chart for a method 90 for purifying impurity-infused water. Block 91 calls for receiving carbon dioxide (CO₂) from a CO₂ input tubular, the CO₂ being at pressure P1, temperature T1, and concentration C1. In one or more embodiments, the pressure P1 is in a range of 25 to 35 bar, the temperature T1 is in a range of −80 to −4° C., and the concentration of CO₂ C1 is greater than 20 mol %.

Block 92 calls for forming CO₂ hydrates using the CO₂ from the CO₂ input tubular and the impurity-infused water in a CO₂ hydrate-former vessel.

Block 93 calls for separating the formed CO₂ hydrates from an impurity solution having impurities removed from the impurity-infused water due to the forming of the CO₂ hydrates. Block 93 may also include discharging the impurity solution from the CO₂ hydrate-former vessel.

Block 94 calls for dissociating the CO₂ hydrates into purified water and dissociated CO₂ by heating the CO₂ hydrates in a CO₂ hydrate-dissociator vessel. Block 94 may also include discharging the purified water.

Block 95 calls for compressing the dissociated CO₂ using a CO₂ compressor to provide compressed CO₂. Block 95 may also include driving the CO₂ compressor with a motor or by water pressure.

Block 96 calls for discharging the compressed CO₂ into a CO₂ output tubular at pressure P2, temperature T2, and concentration C2 within a selected range of C1. For example, C2 may be within 5% of C1. In one or more embodiments, the CO₂ input tubular and the CO₂ output tubular may be one continuous tubular containing CO₂ at substantially (e.g., within 5%) the same pressure, temperature, and concentration.

The disclosure herein provides several advantages. One advantage is that energy can be saved for hydrate formation by pressure reduction and corresponding temperature reduction of CO₂ from the CO₂ discharged by the energy generation section. Another advantage is that the system provides a lower carbon footprint for water purification. Yet another advantage is that the system can purify hypersaline brines and water infused with radioactive elements. Yet another advantage is that the system can provide an additional revenue stream beyond an electric power generation revenue stream. Yet another advantage is that the system can be constructed in modules for lowering the cost of construction.

Embodiment 1: A system for purifying impurity-infused water, the system including a CO₂ input tubular configured to contain carbon dioxide (CO₂) at a pressure P1, a temperature T1, and a concentration C1, a CO₂ output tubular configured to contain CO₂ at a pressure P2, a temperature T2, and a concentration C2, a CO₂ hydrate-former vessel configured to form CO₂ hydrates using the CO₂ from the CO₂ input tubular and the impurity-infused water, the hydrate reactor vessel comprising a CO₂ input coupled to the CO₂ input tubular, an impurity-infused water input coupled to a supply of the impurity-infused water, a CO₂ hydrate output for discharging the formed CO₂ hydrates, and an impurity solution output for discharging an impurity solution having impurities removed from the impurity-infused water by the formation of the CO₂ hydrates, a CO₂ hydrate-dissociator vessel configured to dissociate the CO₂ hydrates into purified water and dissociated CO₂ by heating the CO₂ hydrates, the dissociation unit comprising a CO₂ hydrate input coupled to the CO₂ hydrate output of the hydrate-former vessel, a CO₂ output to discharge the dissociated CO₂, and a heating device configured to heat the CO₂ hydrates; and a CO₂ compressor configured to compress the dissociated CO₂, the CO₂ compressor comprising a compressor CO₂ input coupled to the CO₂ output of the hydrate-dissociator vessel and a compressor CO₂ output coupled to the CO₂ output tubular.

Embodiment 2: The system for purifying impurity-infused water as in any prior embodiment, wherein the compressor comprises one of a motor-driven axial compressor, a motor-driven centrifugal compressor, or a water-driven piston compressor, the water-driven piston compressor comprising a piston, a first side of the piston being in fluid communication with the compressor CO₂ input and the compressor CO₂ output and a second side of the piston being in fluid communication with pressurized water having a pressure sufficient to compress the CO₂ on the first side of the piston, wherein the pressurized water is supplied by a pump receiving water from the supply of the impurity-infused water.

Embodiment 3: The system for purifying impurity-infused water as in any prior embodiment, wherein the CO₂ input tubular is coupled to an upstream system that provides CO₂ to the CO₂ input tubular at the pressure P1 in a range of 25 to 35 bar, the temperature T1 in a range of −80 to −4° C., and the concentration of CO₂ C1 greater than 20 mol %.

Embodiment 4: The system for purifying impurity-infused water as in any prior embodiment, wherein the CO₂ input tubular is coupled to an upstream system that provides CO₂ at a pressure P0 at least 100 bar, a temperature T0 less than 25° C., and a concentration of CO₂ C0 greater than 20 mol %, and the system for purifying impurity-infused water comprises a pressure reduction device disposed between the upstream system and the CO₂ input tubular and configured to reduce the pressure of the CO₂ to P1 and the temperature of the CO₂ to T1 with a CO₂ concentration C1, the pressure reduction device comprising (i) an expansion valve or (ii) a turbo-expander.

Embodiment 5: The system for purifying impurity-infused water as in any prior embodiment, wherein the upstream system comprises a cryogenic CO₂ separation unit configured to receive a flue gas at ambient pressure and temperature and CO₂ concentration in a range of 3 to 14 mol % and separate CO₂ from the flue gas using a cryogenic separation process having a CO₂ output coupled to the CO₂ input tubular, the separated CO₂ having a pressure P0 in the range of 25 to 35 bar, a temperature T0 in the range of −80 to −4° C., and a concentration C0 greater than 20 mol %, and the system for purifying impurity-infused water does not include a pressure reducing device disposed between the upstream system and the CO₂ input tubular, the cryogenic separation process further having a discharge of a CO₂ free stream with a CO₂ concentration less than 3 mol %.

Embodiment 6: The system for purifying impurity-infused water as in any prior embodiment, wherein the upstream system comprises a cryogenic CO₂ separation unit configured to receive a flue gas at ambient pressure and temperature and CO₂ concentration in a range of 3 to 14 mol % and separate CO₂ from the flue gas using a cryogenic separation process having a CO₂ output coupled to the CO₂ input tubular, the separated CO₂ having a pressure P0 in a range of 30 to 60 bar, a temperature T0 less than −10° C., and a concentration C0 greater than 20 mol %, and the system for purifying impurity-infused water comprises a pressure reducing device disposed between upstream system and the CO₂ input tubular, the pressure reducing device comprising (i) a pressure reducing valve or (ii) a turbo-expander.

Embodiment 7: The system for purifying impurity-infused water as in any prior embodiment, wherein the upstream system comprises an energy generation unit comprising a power cycle configured to generate the energy by combusting a fuel and an oxidant and to discharge a CO₂ output stream at the pressure P1, the temperature T1, and the concentration C1.

Embodiment 8: The system for purifying impurity-infused water as in any prior embodiment, wherein the energy generation unit comprises an Allam power cycle having supercritical CO₂ as a working fluid, the energy generation unit being coupled to an upstream CO₂ tubular and configured to discharge a CO₂ output stream into the upstream CO₂ tubular at a pressure P0 being at least 100 bar, a temperature T0 being less than 25° C., and a concentration C0 being greater than 20 mol % and the system for purifying impurity-infused water comprises a pressure reduction device disposed between the upstream CO₂ tubular and the CO₂ input tubular and configured to reduce the pressure of the CO₂ to P1 and the temperature of the CO₂ to T1 with concentration C1, the pressure reduction device comprising (i) a pressure reducing valve or (ii) a turbo-expander.

Embodiment 9: The system for purifying impurity-infused water as in any prior embodiment, wherein the energy generation (EG) unit comprises a gas turbine coupled to a load comprising an electric generator or a mechanical drive system and having an exhaust received by a chilled ammonia process (CAP) unit configured to separate CO₂ from the exhaust, the EG unit further comprising an EG unit CO₂ compressor and an optional precooler configured to compress and optionally precool separated CO₂ from the CAP unit, and having a CO₂ outlet coupled to the CO₂ input tubular, wherein the CO₂ concentration entering the CO₂ input tubular is greater than 20 mol %.

Embodiment 10: The system for purifying impurity-infused water as in any prior embodiment, wherein the energy generation unit comprises a gas turbine coupled to a first load comprising a first electric generator or a first mechanical drive system, and generating steam by recovering heat energy from an exhaust of the gas turbine using a heat recovery steam generator (HRSG) coupled to the exhaust of the gas turbine by expanding the steam in a steam turbine coupled to a second load comprising a second electric generator or a second mechanical drive, the system for purifying impurity-infused water further comprises (i) a chilled ammonia process (CAP) unit configured to separate CO₂ from the exhaust gas deriving from the gas turbine exiting the HRSG after energy exchange to provide separated CO₂ and (ii) a CO₂ compressor and optional precooler configured to compress and optionally precool the separated CO₂ to provide compressed and optionally precooled CO₂ as the stream of CO₂.

Embodiment 11: The system for purifying impurity-infused water as in any prior embodiment, wherein the impurity-infused water comprises at least one of a salt-infused water or radioactive particle-infused water.

Embodiment 12: A method for purifying impurity-infused water, the method including receiving carbon dioxide (CO₂) from a CO₂ input tubular configured to contain CO₂ at a pressure P1, a temperature T1, and a concentration C1, forming CO₂ hydrates using the CO₂ from the CO₂ input tubular and the impurity-infused water in a CO₂ hydrate-former vessel, dissociating the CO₂ hydrates into purified water and dissociated CO₂ by heating the CO₂ hydrates in a CO₂ hydrate-dissociator vessel, compressing the dissociated CO₂ using a CO₂ compressor to provide compressed CO₂; and discharging the compressed CO₂ into a CO₂ output tubular at a pressure P2, a temperature T2, and a concentration C2 within a selected range of C1.

Embodiment 13: The method as in any prior embodiment, wherein compressing comprises using one of a motor-driven axial compressor, a motor-driven centrifugal compressor, or a water-driven piston compressor, the water-driven piston compressor comprising a piston, a first side of the piston being in fluid communication with the compressor CO₂ input and the compressor CO₂ output and a second side of the piston being in fluid communication with pressurized water having a pressure sufficient to compress the CO₂ on the first side of the piston, wherein the pressurized water is supplied by a pump receiving water from the supply of the impurity-infused water.

Embodiment 14: The method as in any prior embodiment, wherein the pressure P1 is in a range of 25 to 35 bar, the temperature T1 is in a range of −80 to −4° C., and the concentration of CO₂ C1 is greater than 20 mol %.

Embodiment 15: The method as in any prior embodiment, further including receiving CO₂ from an upstream system that provides CO₂ at a pressure P0 that is at least 100 bar, a temperature T0 that is less than 25° C., and a concentration of CO₂ C0 that is greater than 20 mol %, and reducing pressure of the CO₂ from the upstream system to P1 and temperature of the CO₂ from the upstream system to T1 with a CO₂ concentration C1 using a pressure reduction device comprising (i) an expansion valve or (ii) a turbo-expander.

Embodiment 16: The method as in any prior embodiment, wherein the upstream system comprises a cryogenic CO₂ separation unit the method further includes receiving a flue gas at ambient pressure and temperature and CO₂ concentration in a range of 3 to 14 mol % with the cryogenic CO₂ separation unit, separating CO₂ from the flue gas using the cryogenic CO₂ separation unit implementing a cryogenic separation process, providing separated CO₂ to the CO₂ input tubular at pressure P1, temperature T1, and concentration C1, and discharging a CO₂ free stream with a CO₂ concentration less than 3 mol % from the cryogenic CO₂ separation unit, wherein the method does not include reducing pressure and temperature of the separated CO₂ using a pressure reduction device.

Embodiment 17: The method as in any prior embodiment, wherein the upstream system comprises a cryogenic CO₂ separation unit and the method further includes receiving a flue gas at ambient pressure and temperature and CO₂ concentration in a range of 3 to 14 mol %, separating CO₂ from the flue gas using the cryogenic CO₂ separation unit implementing a cryogenic separation process to provide separated CO₂ having a pressure P0 in a range of 30 to 60 bar, a temperature T0 that is less than −10° C., and a concentration C0 that is greater than 20 mol %, reducing the pressure of the separated CO₂ to P1 and the temperature of the separated CO₂ to T1 using a pressure reduction device comprising (i) an expansion valve or (ii) a turbo-expander disposed between the cryogenic CO₂ separation unit and the CO₂ input tubular, and providing separated CO₂ at reduced pressure to the CO₂ input tubular at pressure P1, temperature T1, and concentration C1.

Embodiment 18: The method as in any prior embodiment, wherein the upstream system comprises an energy generation unit and the method further includes generating energy by combusting a fuel and an oxidant using the energy generation unit configured to discharge a stream of CO₂ at the pressure P1, the temperature T1, and the concentration C1, and providing the stream of CO₂ to the CO₂ input tubular.

Embodiment 19: The method as in any prior embodiment, wherein the energy generation unit comprises an Allam power cycle having supercritical CO₂ as a working fluid and the method further includes discharging a CO₂ output stream from the Allam power cycle at a pressure P0 being at least 100 bar, a temperature T0 being less than 25° C., and a concentration C0 being greater than 20 mol %, reducing the pressure of the discharged CO₂ to P1 and the temperature of the discharged CO₂ to T1 using a pressure reduction device comprising (i) an expansion valve or (ii) a turbo-expander disposed between the energy generation unit and the CO₂ input tubular, and providing the discharged CO₂ at reduced pressure as the stream of CO₂ to the CO₂ input tubular.

Embodiment 20: The method as in any prior embodiment, wherein the energy generation unit comprises a gas turbine coupled to a load comprising an electric generator or a mechanical drive system and the method further includes receiving an exhaust of the gas turbine by a chilled ammonia process (CAP) unit configured to separate CO₂ from the exhaust to provide separated CO₂, compressing and optionally precooling the separated CO₂ using a CO₂ compressor and optionally a precooler to provide compressed and optionally precooled CO₂, and providing the compressed and optionally precooled CO₂ to the CO₂ input tubular, wherein a concentration of CO₂ entering the CO₂ input tubular is greater than 20 mol %.

Embodiment 21: The method as in any prior embodiment, wherein the energy generation unit comprises a gas turbine coupled to a first load comprising a first electric generator or a first mechanical drive system, and the method further includes generating steam by recovering heat energy from an exhaust of the gas turbine using a heat recovery steam generator (HRSG) coupled to the exhaust of the gas turbine, generating energy by expanding the steam in a steam turbine coupled to a second load comprising a second electric generator or a second mechanical drive system, receiving the exhaust of the gas turbine, after energy exchange with HRSG, by a chilled ammonia process (CAP) unit configured to separate CO₂ from the exhaust of the gas turbine to provide separated CO₂, compressing and optionally precooling the separated CO₂ using a CO₂ compressor and optionally a precooler to provide compressed and optionally precooled CO₂, and providing the compressed and optionally precooled CO₂ to the CO₂ input tubular, wherein a concentration of CO₂ entering the CO₂ input tubular is greater than 20 mol %.

Embodiment 22: The method as in any prior embodiment, wherein the impurity-infused water comprises at least one of a salt-infused water or radioactive particle-infused water.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates to one or more structural limitations of a device that are required for the device to perform the function or operation for which the device is configured. The limitations may be known in the art for a specific item, but not known in the context of or application to the invention as a whole. The limitations may be inclusive of circuit modules and software known to perform a specific function. The term “coupled” relates to being coupled directly or indirectly using an intermediate device. The terms “first” and “second” and like are used to distinguish terms and not to denote a particular order.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed:

1. A system for purifying impurity-infused water, the system comprising:
a CO₂ input tubular configured to contain carbon dioxide (CO₂) at a pressure P1, a temperature T1, and a concentration C1;
a CO₂ output tubular configured to contain CO₂ at a pressure P2, a temperature T2, and a concentration C2;
a CO₂ hydrate-former vessel configured to form CO₂ hydrates using the CO₂ from the CO₂ input tubular and the impurity-infused water, the hydrate reactor vessel comprising a CO₂ input coupled to the CO₂ input tubular, an impurity-infused water input coupled to a supply of the impurity-infused water, a CO₂ hydrate output for discharging the formed CO₂ hydrates, and an impurity solution output for discharging an impurity solution having impurities removed from the impurity-infused water by the formation of the CO₂ hydrates;
a CO₂ hydrate-dissociator vessel configured to dissociate the CO₂ hydrates into purified water and dissociated CO₂ by heating the CO₂ hydrates, the dissociation unit comprising a CO₂ hydrate input coupled to the CO₂ hydrate output of the hydrate-former vessel, a CO₂ output to discharge the dissociated CO₂, and a heating device configured to heat the CO₂ hydrates; and
a CO₂ compressor configured to compress the dissociated CO₂, the CO₂ compressor comprising a compressor CO₂ input coupled to the CO₂ output of the hydrate-dissociator vessel and a compressor CO₂ output coupled to the CO₂ output tubular.

2. The system for purifying impurity-infused water according to claim 1, wherein the compressor comprises one of a motor-driven axial compressor, a motor-driven centrifugal compressor, or a water-driven piston compressor, the water-driven piston compressor comprising a piston, a first side of the piston being in fluid communication with the compressor CO₂ input and the compressor CO₂ output and a second side of the piston being in fluid communication with pressurized water having a pressure sufficient to compress the CO₂ on the first side of the piston, wherein the pressurized water is supplied by a pump receiving water from the supply of the impurity-infused water.

3. The system for purifying impurity-infused water according to claim 1, wherein the CO₂ input tubular is coupled to an upstream system that provides CO₂ to the CO₂ input tubular at the pressure P1 in a range of 25 to 35 bar, the temperature T1 in a range of −80 to −4° C., and the concentration of CO₂ C1 greater than 20 mol %.

4. The system for purifying impurity-infused water according to claim 3, wherein the CO₂ input tubular is coupled to an upstream system that provides CO₂ at a pressure P0 at least 100 bar, a temperature T0 less than 25° C., and a concentration of CO₂ C0 greater than 20 mol %, and the system for purifying impurity-infused water comprises a pressure reduction device disposed between the upstream system and the CO₂ input tubular and configured to reduce the pressure of the CO₂ to P1 and the temperature of the CO₂ to T1 with a CO₂ concentration C1, the pressure reduction device comprising (i) an expansion valve or (ii) a turbo-expander.

5. The system for purifying impurity-infused water according to claim 3, wherein the upstream system comprises a cryogenic CO₂ separation unit configured to receive a flue gas at ambient pressure and temperature and CO₂ concentration in a range of 3 to 14 mol % and separate CO₂ from the flue gas using a cryogenic separation process having a CO₂ output coupled to the CO₂ input tubular, the separated CO₂ having a pressure P0 in the range of 25 to 35 bar, a temperature T0 in the range of −80 to −4° C., and a concentration C0 greater than 20 mol %, and the system for purifying impurity-infused water does not include a pressure reducing device disposed between the upstream system and the CO₂ input tubular, the cryogenic separation process further having a discharge of a CO₂ free stream with a CO₂ concentration less than 3 mol %.

6. The system for purifying impurity-infused water according to claim 3, wherein the upstream system comprises a cryogenic CO₂ separation unit configured to receive a flue gas at ambient pressure and temperature and CO₂ concentration in a range of 3 to 14 mol % and separate CO₂ from the flue gas using a cryogenic separation process having a CO₂ output coupled to the CO₂ input tubular, the separated CO₂ having a pressure P0 in a range of 30 to 60 bar, a temperature T0 less than −10° C., and a concentration C0 greater than 20 mol %, and the system for purifying impurity-infused water comprises a pressure reducing device disposed between upstream system and the CO₂ input tubular, the pressure reducing device comprising (i) a pressure reducing valve or (ii) a turbo-expander.

7. The system for purifying impurity-infused water according to claim 3, wherein the upstream system comprises an energy generation unit comprising a power cycle configured to generate the energy by combusting a fuel and an oxidant and to discharge a CO₂ output stream at the pressure P1, the temperature T1, and the concentration C1.

8. The system for purifying impurity-infused water according to claim 7, wherein the energy generation unit comprises an Allam power cycle having supercritical CO₂ as a working fluid, the energy generation unit being coupled to an upstream CO₂ tubular and configured to discharge a CO₂ output stream into the upstream CO₂ tubular at a pressure P0 being at least 100 bar, a temperature T0 being less than 25° C., and a concentration C0 being greater than 20 mol % and the system for purifying impurity-infused water comprises a pressure reduction device disposed between the upstream CO₂ tubular and the CO₂ input tubular and configured to reduce the pressure of the CO₂ to P1 and the temperature of the CO₂ to T1 with concentration C1, the pressure reduction device comprising (i) a pressure reducing valve or (ii) a turbo-expander.

9. The system for purifying impurity-infused water according to claim 7, wherein the energy generation (EG) unit comprises a gas turbine coupled to a load comprising an electric generator or a mechanical drive system and having an exhaust received by a chilled ammonia process (CAP) unit configured to separate CO₂ from the exhaust, the EG unit further comprising an EG unit CO₂ compressor and an optional precooler configured to compress and optionally precool separated CO₂ from the CAP unit, and having a CO₂ outlet coupled to the CO₂ input tubular, wherein the CO₂ concentration entering the CO₂ input tubular is greater than 20 mol %.

10. The system for purifying impurity-infused water according to claim 7, wherein the energy generation unit comprises a gas turbine coupled to a first load comprising a first electric generator or a first mechanical drive system, and generating steam by recovering heat energy from an exhaust of the gas turbine using a heat recovery steam generator (HRSG) coupled to the exhaust of the gas turbine by expanding the steam in a steam turbine coupled to a second load comprising a second electric generator or a second mechanical drive, the system for purifying impurity-infused water further comprises (i) a chilled ammonia process (CAP) unit configured to separate CO₂ from the exhaust gas deriving from the gas turbine exiting the HRSG after energy exchange to provide separated CO₂ and (ii) a CO₂ compressor and optional precooler configured to compress and optionally precool the separated CO₂ to provide compressed and optionally precooled CO₂ as the stream of CO₂.

11. The system for purifying impurity-infused water according to claim 1, wherein the impurity-infused water comprises at least one of a salt-infused water or radioactive particle-infused water.

12. A method for purifying impurity-infused water, the method comprising:
receiving carbon dioxide (CO₂) from a CO₂ input tubular configured to contain CO₂ at a pressure P1, a temperature T1, and a concentration C1;
forming CO₂ hydrates using the CO₂ from the CO₂ input tubular and the impurity-infused water in a CO₂ hydrate-former vessel;
dissociating the CO₂ hydrates into purified water and dissociated CO₂ by heating the CO₂ hydrates in a CO₂ hydrate-dissociator vessel;
compressing the dissociated CO₂ using a CO₂ compressor to provide compressed CO₂; and
discharging the compressed CO₂ into a CO₂ output tubular at a pressure P2, a temperature T2, and a concentration C2 within a selected range of C1.

13. The method according to claim 12, wherein compressing comprises using one of a motor-driven axial compressor, a motor-driven centrifugal compressor, or a water-driven piston compressor, the water-driven piston compressor comprising a piston, a first side of the piston being in fluid communication with the compressor CO₂ input and the compressor CO₂ output and a second side of the piston being in fluid communication with pressurized water having a pressure sufficient to compress the CO₂ on the first side of the piston, wherein the pressurized water is supplied by a pump receiving water from the supply of the impurity-infused water.

14. The method according to claim 12, wherein the pressure P1 is in a range of 25 to 35 bar, the temperature T1 is in a range of −80 to −4° C., and the concentration of CO₂ C1 is greater than 20 mol %.

15. The method according to claim 14, further comprising:
receiving CO₂ from an upstream system that provides CO₂ at a pressure P0 that is at least 100 bar, a temperature T0 that is less than 25° C., and a concentration of CO₂ C0 that is greater than 20 mol %; and
reducing pressure of the CO₂ from the upstream system to P1 and temperature of the CO₂ from the upstream system to T1 with a CO₂ concentration C1 using a pressure reduction device comprising (i) an expansion valve or (ii) a turbo-expander.

16. The method according to claim 14, wherein the upstream system comprises a cryogenic CO₂ separation unit the method further comprises:
receiving a flue gas at ambient pressure and temperature and CO₂ concentration in a range of 3 to 14 mol % with the cryogenic CO₂ separation unit;
separating CO₂ from the flue gas using the cryogenic CO₂ separation unit implementing a cryogenic separation process;
providing separated CO₂ to the CO₂ input tubular at pressure P1, temperature T1, and concentration C1; and
discharging a CO₂ free stream with a CO₂ concentration less than 3 mol % from the cryogenic CO₂ separation unit;
wherein the method does not include reducing pressure and temperature of the separated CO₂ using a pressure reduction device.

17. The method according to claim 14, wherein the upstream system comprises a cryogenic CO₂ separation unit and the method further comprises:
receiving a flue gas at ambient pressure and temperature and CO₂ concentration in a range of 3 to 14 mol %;
separating CO₂ from the flue gas using the cryogenic CO₂ separation unit implementing a cryogenic separation process to provide separated CO₂ having a pressure P0 in a range of 30 to 60 bar, a temperature T0 that is less than −10° C., and a concentration C0 that is greater than 20 mol %;
reducing the pressure of the separated CO₂ to P1 and the temperature of the separated CO₂ to T1 using a pressure reduction device comprising (i) an expansion valve or (ii) a turbo-expander disposed between the cryogenic CO₂ separation unit and the CO₂ input tubular; and
providing separated CO₂ at reduced pressure to the CO₂ input tubular at pressure P1, temperature T1, and concentration C1.

18. The method according to claim 14, wherein the upstream system comprises an energy generation unit and the method further comprises:
generating energy by combusting a fuel and an oxidant using the energy generation unit configured to discharge a stream of CO₂ at the pressure P1, the temperature T1, and the concentration C1; and
providing the stream of CO₂ to the CO₂ input tubular.

19. The method according to claim 18, wherein the energy generation unit comprises an Allam power cycle having supercritical CO₂ as a working fluid and the method further comprises:
discharging a CO₂ output stream from the Allam power cycle at a pressure P0 being at least 100 bar, a temperature T0 being less than 25° C., and a concentration C0 being greater than 20 mol %;
reducing the pressure of the discharged CO₂ to P1 and the temperature of the discharged CO₂ to T1 using a pressure reduction device comprising (i) an expansion valve or (ii) a turbo-expander disposed between the energy generation unit and the CO₂ input tubular; and
providing the discharged CO₂ at reduced pressure as the stream of CO₂ to the CO₂ input tubular.

20. The method according to claim 18, wherein the energy generation unit comprises a gas turbine coupled to a load comprising an electric generator or a mechanical drive system and the method further comprises:
receiving an exhaust of the gas turbine by a chilled ammonia process (CAP) unit configured to separate CO₂ from the exhaust to provide separated CO₂;
compressing and optionally precooling the separated CO₂ using a CO₂ compressor and optionally a precooler to provide compressed and optionally precooled CO₂; and;
providing the compressed and optionally precooled CO₂ to the CO₂ input tubular;
wherein a concentration of CO₂ entering the CO₂ input tubular is greater than 20 mol %.

21. The method according to claim 18, wherein the energy generation unit comprises a gas turbine coupled to a first load comprising a first electric generator or a first mechanical drive system, and the method further comprises:
generating steam by recovering heat energy from an exhaust of the gas turbine using a heat recovery steam generator (HRSG) coupled to the exhaust of the gas turbine;
generating energy by expanding the steam in a steam turbine coupled to a second load comprising a second electric generator or a second mechanical drive system;
receiving the exhaust of the gas turbine, after energy exchange with HRSG, by a chilled ammonia process (CAP) unit configured to separate CO₂ from the exhaust of the gas turbine to provide separated CO₂;
compressing and optionally precooling the separated CO₂ using a CO₂ compressor and optionally a precooler to provide compressed and optionally precooled CO₂; and
providing the compressed and optionally precooled CO₂ to the CO₂ input tubular;
wherein a concentration of CO₂ entering the CO₂ input tubular is greater than 20 mol %.

22. The method according to claim 12, wherein the impurity-infused water comprises at least one of a salt-infused water or radioactive particle-infused water.
